(19) United States
(12) Patent Application Publication
(10) Pub. No.: US 2007/0039663 A1
(43) Pub. Date: Feb. 22, 2007

(54) Structure of automatic pencil sharpener

(76) Inventor: Shen-Hsiung Chang, Taipei County (TW)

Correspondence Address: BIRCH STEWART KOLASCH & BIRCH, PO BOX 747, FALLS CHURCH, VA, 22040-0747, US

(21) Appl. No.: 11/205,171

(22) Filed: Aug. 17, 2005

(51) Int. Cl. B43L 23/00

(52) U.S. Cl. 144/28.72; 144/28.1

(57) ABSTRACT

An automatic pencil sharpener has a plurality of different sizes of pencil selector openings in a front side of a pencil selector panel, and an annulus groove at the back side of the pencil selector panel for mounting the trigger. Accordingly, the pencil inserted into the pencil receiving opening will keep a constant distance with the trigger switch, regardless of the sizes of the pencil inserted, thereby smoothing the pencil operation in the device.

### BACKGROUND OF THE INVENTION

I. Field of the Invention

The present invention relates to a device of “An Improvement on Automatic Pencil Sharpener,” especially refers to an improvement on the pencil selector panel which changes the position of the trigger switch with the rotation of the pencil selector panel to adjust the suitable pencil size.

II. Description of the Prior Art

A conventional pencil is often used in writing, artifact, and industrial drawing. In our daily life there are various kind of pencils (such as conventional, automatic, and magic pencil etc.). Although conventional pencil has many disadvantages, for those who dedicate to writing, artifact, or industrial drawing, the conventional pencil is a necessary tool. The wooden wrapper covered the pencil column should have to be sharpened into appropriate conical shape to expose the column in proper acute shape for use. Therefore, the preparation of conventional pencil for usage is very time consuming, and as for many users, it is difficult to sharpen the pencil into a good looking shape. The bad looking sharpening pencil will influence the mood of the user and the pencil is not easy for the user to hold. Therefore, the pencil sharpening tools in various types such as semi-automatic, automatic pencil sharpener are introduced into the current market. In general, semi-automatic pencil sharpener requires manual rolling forces to sharpen the pencil into preconfigured type by rotary blade. Additionally, please also refer to the embodiment of FIG. 1, FIG. 2, and FIG. 3, the automatic pencil sharpener primarily comprises a rotary blade a1 powered by automatic motor. The rotary blade a1 forms an angle with the line axis of the pencil receiving opening a2. In the inner side of the pencil receiving opening a2 is set up a switch component a3, which is designed to push trigger a4 to gain the control purpose. The trigger a4 covers half of the pencil receiving opening a2. When in use, inserting pencil into the pencil receiving opening a2 will push the trigger a4 which then releases the switch component a3 to start the motor, and drive the rotary blade a1 to sharpen the pencil b into appropriate conical shape in preconfigured angle. Although such kind of pencil sharpener is convenient to use, pencil with different sizes in the market cannot be inserted, and the sharpener will shake when sharpening a pencil of a smaller size. In order to resolve such kind of problem, directly improve the pencil receiving opening and switch component or introduce pencil selector panel a5 with various size of openings to change the size of opening by rotating the selector panel a5, at the same time the trigger a4 directly contact with the pencil, and the increased pressure on the pencil make it difficult to insert and withdraw the pencil, and needs some sort of improvement.

### SUMMARY OF THE INVENTION

It is therefore a primary object of the present invention to provide a device of an improvement on an automatic pencil sharpener.

It is a further object of the present invention to provide a device which can adjust the location of a trigger switch by the movement of pencil selector panel to make the insert in and off more smoothly.

Thereafter, the present invention of the device on the improvement of an automatic pencil sharpener primarily comprises a pencil sharpener body and pencil selector panel, and characterized by a plurality of different sizes of pencil selecting openings are set up in front of pencil selector panel which has annulus groove at back, while the pencil selector panel is mounted on the emplacing groove, which is in front of the pencil sharpener body, and possess a pencil receiving opening and a plurality of pawls in an appropriate position. A trigger switch is arranged nearby the pencil receiving opening within the reach of a position groove. Above the trigger switch, a trigger key and a trigger corresponding to the size of annulus groove are fixed.

Accordingly, in assembly, the pencil selector panel is fixed on the emplacing groove of the front pencil sharpener body, and insert the trigger of the trigger switch into the annulus groove of the pencil selector panel corresponding back. Therefore, when rotating the pencil selector panel, the trigger will move along with the inner annulus groove, and drive the trigger switch to move linearly along with position groove to make the location of the trigger key changes by the different pencil openings selected and smooth the insert in and out of the. Consequently, it reduces the inconvenience of inserting pencil in and out of the conventional pencil sharpeners.

### BRIEF DESCRIPTION OF THE DRAWINGS

FIG. 1 shows the cross-sectional view of conventional pencil sharpener;

FIG. 2 shows the front elevational view of the conventional sharpener (1);

FIG. 3 shows the front elevational view of the conventional sharpener (2);

FIG. 4 shows the broken perspective view of the present invention;

FIG. 5 shows the assembly perspective view of the present invention;

FIG. 6 shows the partially cross-sectional view of the present invention;

FIG. 7 shows the practical application view of the present invention (1); and

FIG. 8 shows the practical application view of the present invention (2).

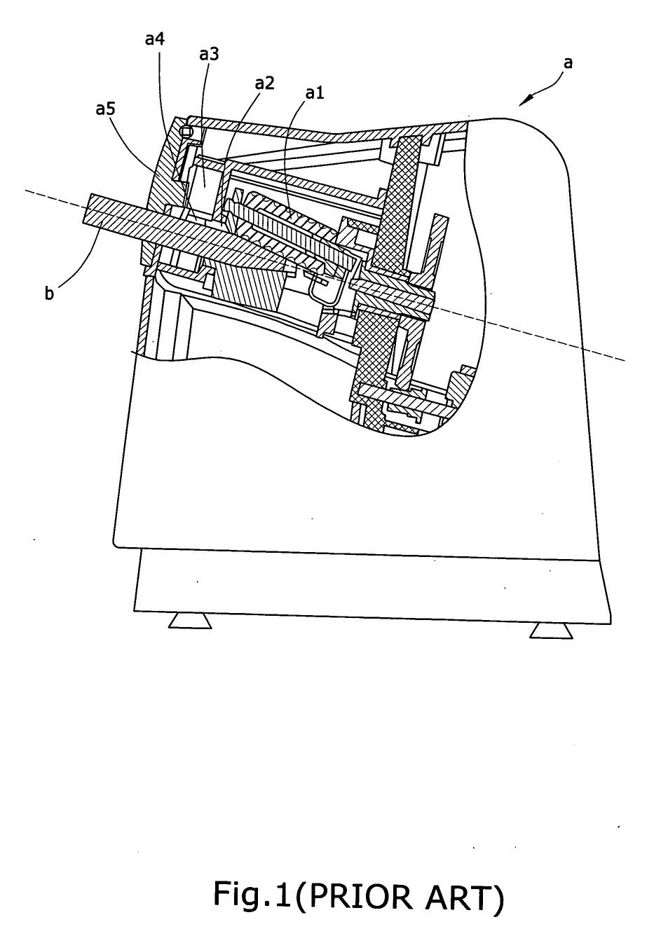

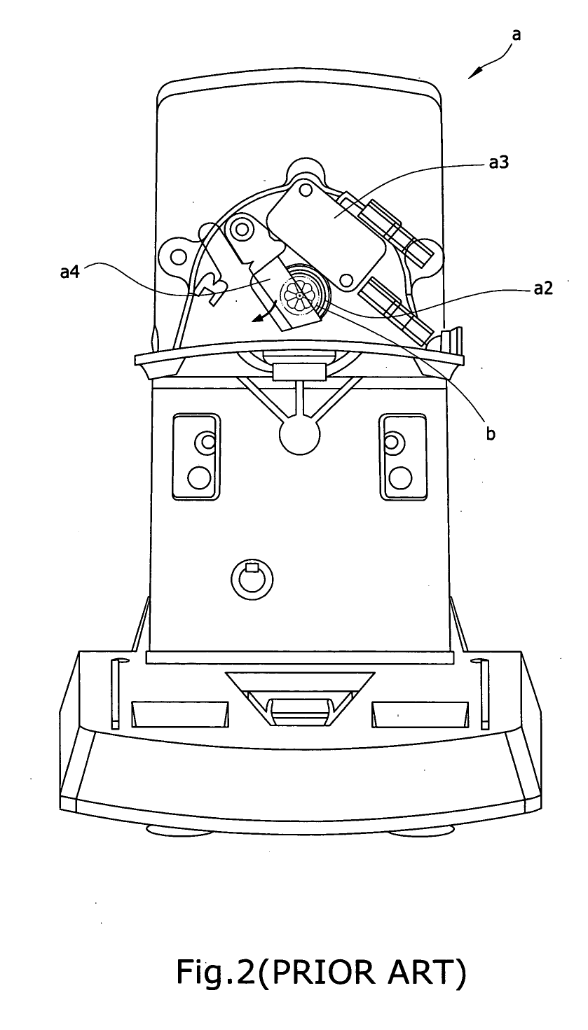

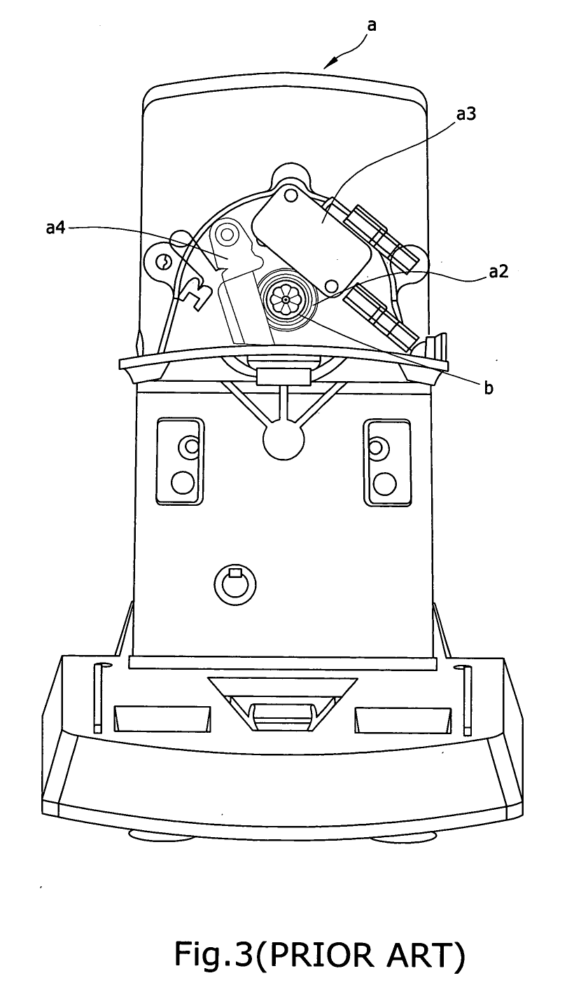

### DETAILED DESCRIPTION OF THE PREFERRED EMBODIMENTS

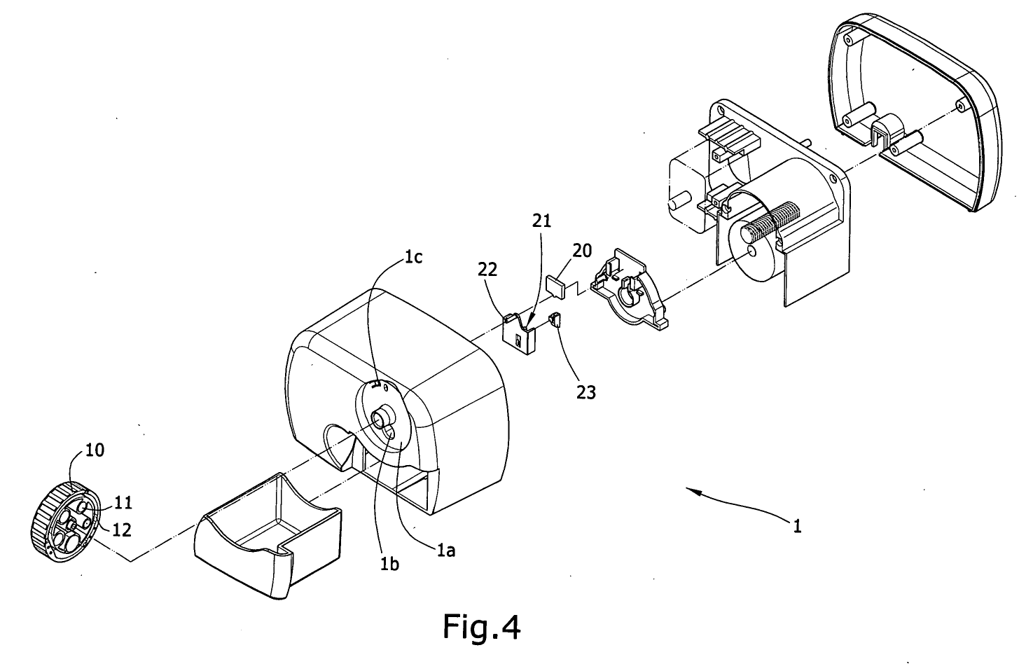

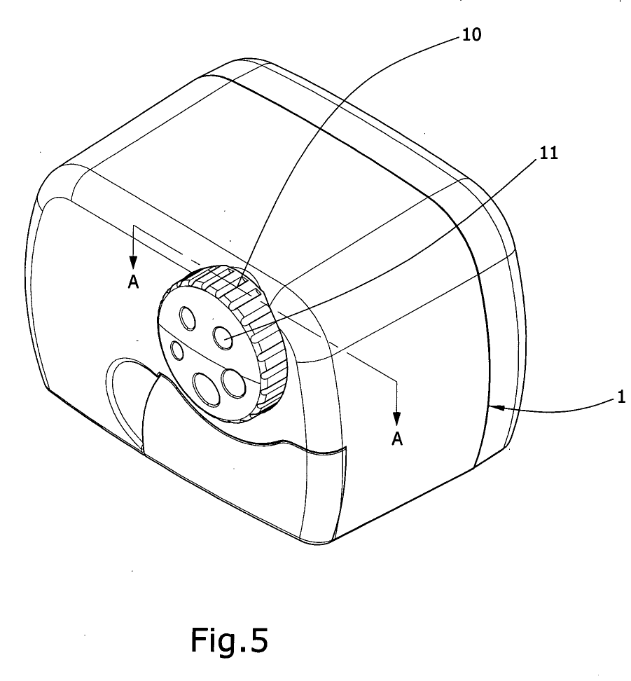

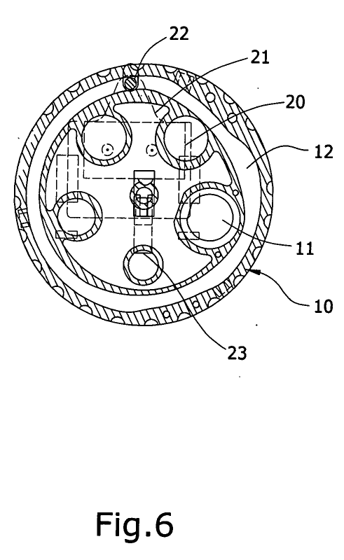

First of all, referring to the embodiment of FIG. 4, FIG. 5, and FIG. 6, the device of “an improvement on the automatic pencil sharpener” in accordance with the present invention primarily comprises the pencil sharpener body 1, and a pencil selector panel.

A plurality of pencil selecting openings 11 are set up in front of the pencil selector panel 10 which has annulus groove 12 at the back side of the pencil selector panel 10, while the pencil selector panel 10 is mounted on the emplacing groove 1a which is in front of the pencil sharpener body 1, and possess a pencil receiving opening 1b and a plurality of pawls 1c in an appropriate position. A trigger switch 20 is arranged nearby the pencil receiving opening 1b within a position groove 21 dynamically. Above the trigger switch 20, a trigger key 23 and a trigger 22 responding to the size of annulus groove 12 are fixed.

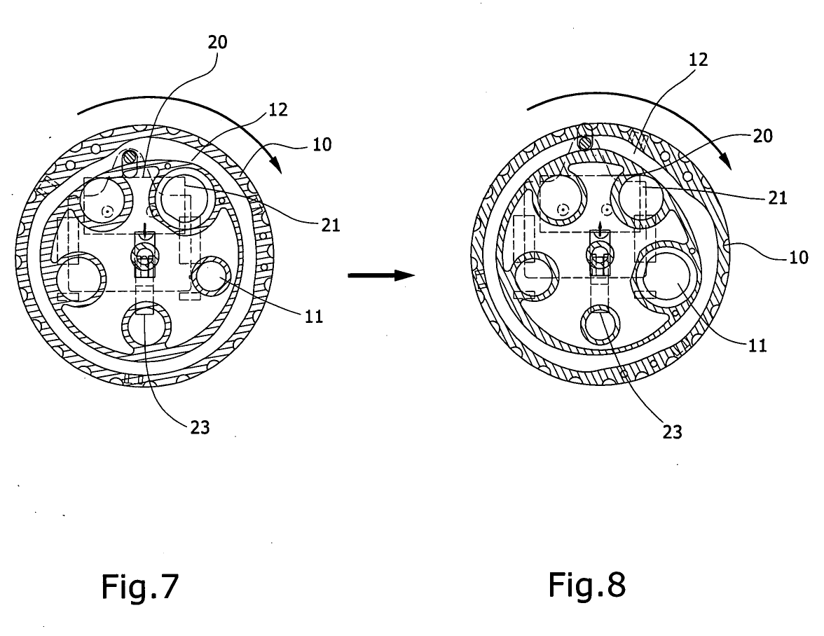

Referring to the embodiment of FIGS. 6-8, when rotating the pencil selector panel 10, the trigger 22 will move along with the inner annulus groove 12, and drive the trigger switch 20 to move linearly along with position groove 21 by taking advantage of the different curvature of the annulus groove 12 and the predefined distance among the corresponding pencil openings 11 to make the pencil receiving opening 11 in alignment with the pencil opening selected.

In summary, the present invention relates to “An Improvement on Automatic Pencil Sharpener” taking advantage of the movement of the pencil selector panel to drive the trigger to move in the annulus groove and drive trigger switch to move linearly corresponding to the pencil opening selected. Therefore, the present can make the insertion and withdrawal easier.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A automatic pencil sharpener comprises:
a pencil sharpener body having an emplacing groove;
a front pencil selector panel including:
a plurality of different sizes of pencil selecting openings at a front side of the front pencil selector panel; and
an annulus groove at a back side of the front pencil selector panel, the annulus groove surrounding the pencil selecting openings;
wherein the front pencil selector panel is mounted on the emplacing groove of the pencil sharpener body, and the emplacing groove possess a pencil receiving opening and a plurality of pawls in an appropriate position;
a trigger switch arranged nearby the pencil receiving opening and movable along a position groove;
a trigger located within the annulus groove, the trigger moving along an inner wall of the annulus groove when the front pencil selector panel is rotated.

2. The automatic pencil sharpener of claim 1, wherein the trigger is spaced apart from the pencil selecting openings so as to being free of contact with a pencil when the pencil is inserted into one of the pencil selecting openings.

3. The automatic pencil sharpener of claim 1, wherein the trigger is in contact with the inner wall of the annulus groove.

4. The automatic pencil sharpener of claim 1, wherein the trigger moves along a vertical direction when the front pencil selector panel is rotated.

5. The automatic pencil sharpener of claim 1, wherein the position groove extends along a vertical direction and the trigger switch moves along the position groove in the vertical direction.
